(19) United States
(12) Patent Application Publication
(10) Pub. No.: US 2015/0205965 A1
(43) Pub. Date: Jul. 23, 2015

(54) SYSTEMS AND METHODS FOR DETERMINING OVERALL RISK MODIFICATION AMOUNTS

(71) Applicant: LexisNexis, a division of Reed Elsevier Inc., Miamisburg, OH (US)

(72) Inventors: William Kilgallon, Lebanon, OH (US); Roger Cass, Miamisburg, OH (US)

(73) Assignee: LexisNexis, a division of Reed Elsevier Inc., Miamisburg, OH (US)

(21) Appl. No.: 14/160,676

(22) Filed: Jan. 22, 2014

(51) Int. Cl. G06F 21/57

(52) U.S. Cl. CPC G06F 21/577

(57) ABSTRACT

Systems and computer-implemented methods for determining overall risk modification indicative of an amount by which an overall risk associated with a plurality of threats is modified by implementing a combination of security controls are disclosed. A computer-implemented method includes receiving a plurality of individual risk modification amounts. Each individual risk modification amount corresponds to a corresponding security control of the combination of security controls and a corresponding threat of the plurality of threats. Each individual risk modification amount of the plurality of individual risk modification amounts is indicative of an amount by which a risk associated with the corresponding threat is modified by implementing the corresponding security control. The method further includes determining, automatically by a computer, the overall risk modification amount based on the plurality of individual risk modification amounts.

### BACKGROUND

1. Field

The present specification generally relates to risk modification determination and, more particularly, to systems and methods for determining an amount by which an overall risk associated with a plurality of threats is modified by implementing a combination of security controls.

2. Technical Background

There may be a number of threats that pose risk to the access of a computer system or database. For example, threats include an unauthorized user obtaining login credentials from an otherwise authorized user and obtaining unauthorized access to the computer system or database in a variety of ways (e.g., guessing login credentials, obtaining login credentials through a phishing scam, obtaining login credentials through keyboard logging, and the like). Entities charged with minimizing such risk to access to computer systems and/or databases may be charged with choosing from a wide variety of possible security controls that may be implemented to mitigate such risks. However, it is often difficult to make a principled and educated choice of which security controls to implement to mitigate such risk.

Accordingly, a need exists for methods and systems for determining an overall risk modification amount indicative of an amount by which an overall risk associated with a plurality of threats is modified by implementing a combination of security controls.

### SUMMARY

In one embodiment, a computer-implemented method for determining an overall risk modification amount indicative of an amount by which an overall risk associated with a plurality of threats is modified by implementing a combination of security controls includes receiving a plurality of individual risk modification amounts. Each individual risk modification amount corresponds to a corresponding security control of the combination of security controls and a corresponding threat of the plurality of threats. Each individual risk modification amount of the plurality of individual risk modification amounts is indicative of an amount by which a risk associated with the corresponding threat is modified by implementing the corresponding security control. The method further includes determining, automatically by a computer, the overall risk modification amount based on the plurality of individual risk modification amounts. The overall risk modification amount is indicative of the amount by which the overall risk associated with the plurality of threats is modified by implementing the combination of security controls.

In another embodiment, a system for determining an overall risk modification amount indicative of an amount by which an overall risk associated with a plurality of threats is modified by implementing a combination of security controls includes a computing device that includes a non-transitory memory component that stores a set of executable instructions. The set of executable instructions cause the computing device to receive a plurality of individual risk modification amounts. Each individual risk modification amount corresponds to a corresponding security control of the combination of security controls and a corresponding threat of the plurality of threats. Each individual risk modification amount of the plurality of individual risk modification amounts is indicative of an amount by which a risk associated with the corresponding threat is modified by implementing the corresponding security control. The set of executable instructions further cause the computing device to determine the overall risk modification amount based on the plurality of individual risk modification amounts. The overall risk modification amount is indicative of the amount by which the overall risk associated with the plurality of threats is modified by implementing the combination of security controls.

In yet another embodiment, a computer-implemented method for determining an overall risk modification amount indicative of an amount by which an overall risk associated with a plurality of threats is modified by implementing a combination of security controls includes receiving a plurality of individual risk modification amounts. Each individual risk modification amount corresponds to a corresponding security control of the combination of security controls and a corresponding threat of the plurality of threats. Each individual risk modification amount of the plurality of individual risk modification amounts is indicative of an amount by which a risk associated with the corresponding threat is modified by implementing the corresponding security control. The method further includes determining, automatically by a computer, the overall risk modification amount based on the plurality of individual risk modification amounts. The overall risk modification amount is indicative of the amount by which the overall risk associated with the plurality of threats is modified by implementing the combination of security controls. The method further includes providing for display the overall risk modification amount on a display device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a computer device for determining an overall risk modification amount, depicting hardware and software that may be utilized in determining an overall risk modification amount, according to one or more embodiments shown and described herein;

FIG. 2 depicts a schematic illustration of an exemplary user interface for facilitating the determination of an amount by which an overall risk associated with a plurality of threats is modified by implementing a first combination of security controls, along with other relevant metrics associated with implementing the first combination of security controls, according to one or more embodiments shown and described herein;

FIG. 3 depicts a schematic illustration of an exemplary user interface for facilitating the determination of an amount by which an overall risk associated with a plurality of threats is modified by implementing a second combination of security controls, along with other relevant metrics associated with implementing the second combination of security controls, according to one or more embodiments shown and described herein;

FIG. 4 depicts a schematic illustration of an exemplary user interface for facilitating the determination of an amount by which an overall risk associated with a plurality of threats is modified by implementing a third combination of security controls, along with other relevant metrics associated with implementing the third combination of security controls, according to one or more embodiments shown and described herein; and

FIG. 5 depicts a schematic illustration of a comparative graphical summary of the overall risk modification amounts and other relevant metrics associated with implementing the first combination of security controls, the second combination of security controls, and the third combination of security controls, according to one or more embodiments shown and described herein.

### DETAILED DESCRIPTION

As noted in the background, there may be a number of threats that pose risk to the access of a computer system or database. For example, login credentials may be stolen through a guessing attack, a user's password may be stolen from another site and used by another to gain access a computer system or database, a malware infection on a user's desktop may steal credentials that may be used to gain access to a computer system or database, a username or password information may be fraudulently obtained through a phishing scheme, or the like. A variety of security controls may be implemented in order to mitigate such risks. For example, a mandatory password change may be imposed every 90 days, a user may be required to register a new machine in some manner before allowing accessing to a computer system or database via the new machine, a custom picture may be selected and shown on the sign-in page, statistically based fraudulent activity detection and reaction control may be employed, failed password detection and reaction control may be employed, and the like.

The systems and methods described herein may determine an overall risk modification amount indicative of an amount by which an overall risk associated with a plurality of threats is modified by implementing a particular combination of security controls. The systems and methods described herein may provide a powerful methodology by which the complicated and intertwined interrelation of multiple individual security controls and multiple possible threat scenarios may combine to influence an overall risk modification that results from implementing a combination of security controls. By understanding the overall risk modification amount associated with implementing a plurality of security controls, an evaluation can be made of whether a particular combination of security controls is effective. Furthermore, by calculating the overall risk modification amounts and other metrics associated with implementing different combinations of security controls and presenting such information to a user, a user may be able to understand the tradeoffs associated with implementing the various combinations of security controls, thereby enabling the user to evaluate which combination of security controls to implement. Various systems and methods will now be described in further details with reference to the figures.

The systems and methods described herein may generally determine an overall risk modification amount indicative of an amount by which an overall risk associated with a plurality of threats is modified by implementing a combination of security controls by receiving a plurality of individual risk modification amounts and automatically determining the overall risk modification amount based on the plurality of individual risk modification amounts. Each individual risk modification amount of the plurality of risk modification amounts is indicative of an amount by which a risk associated with a corresponding threat is modified by implementing a corresponding security control. The overall risk modification amount is indicative of the amount by which the overall risk associated with the plurality of threats is modified by implementing the combination of security controls.

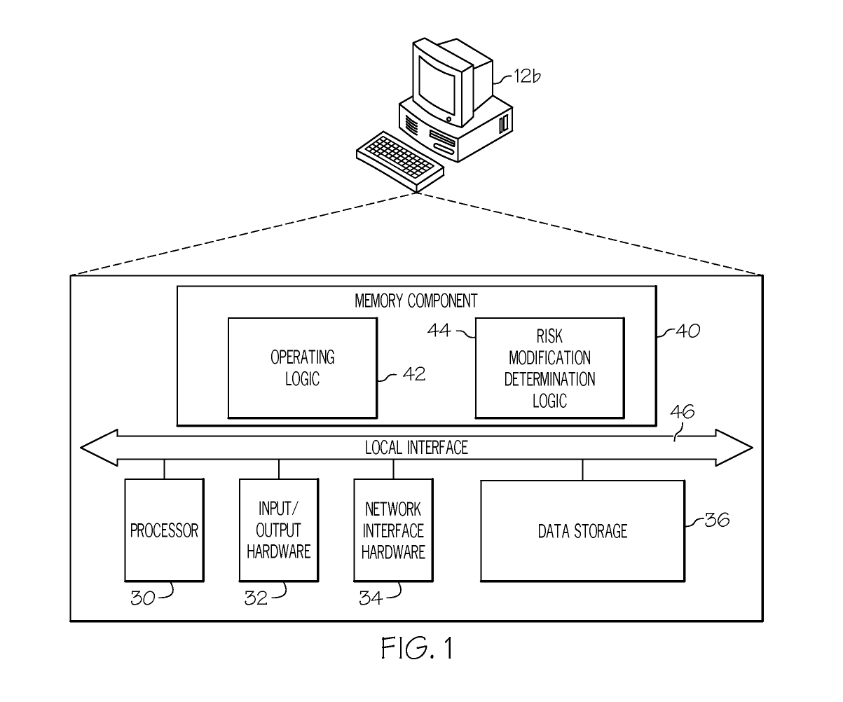

Referring now to the drawings, FIG. 1 depicts a computing device 12 for determining an overall risk modification amount and performing the other computer-implemented operations described herein, and/or a non-transitory computer-readable medium for determining an overall risk modification amount and performing the other computer-implemented operations described herein, embodied as hardware, software, and/or firmware, according to embodiments shown and described herein. While in some embodiments, the computing device 12 may be configured as a general purpose computer with the requisite hardware, software, and/or firmware, in some embodiments, that computing device 12 may be configured as a special purpose computer designed specifically for performing the functionality described herein.

As illustrated in FIG. 1, the computing device 12 may include a processor 30, input/output hardware 32, network interface hardware 34, a data storage component 36, and a memory component 40. The memory component 40 may be configured as volatile and/or nonvolatile computer readable medium and, as such, may include random access memory (including SRAM, DRAM, and/or other types of random access memory), hard disk drives (HDD), flash memory, registers, compact discs (CD), digital versatile discs (DVD), Blu-Ray discs, and/or other types of storage components. Additionally, the memory component 40 may be configured to store operating logic 42 and risk modification determination logic 44 (each of which may be embodied as a computer program, firmware, or hardware, as an example). A local interface 46 is also included in FIG. 1 and may be implemented as a bus or other interface to facilitate communication among the components of the computing device 12.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices. It should be understood that the data storage component 36 may reside local to and/or remote from the computing device 12 and may be configured to store one or more pieces of data for access by the computing device 12 and/or other components.

Included in the memory component 40 are the operating logic 42 and the risk modification determination logic 44. The operating logic 42 may include an operating system and/or other software for managing components of the computing device 12. Similarly, the risk modification determination logic 44 may reside in the memory component 40 and may be configured to determine an overall risk modification amount indicative of an amount by which an overall risk associated with a plurality of threats is modified by implementing a combination of security controls, as will be described in detail below with reference to the remaining figures.

It should be understood that the components illustrated in FIG. 1 are merely exemplary and are not intended to limit the scope of this disclosure. Specifically, although FIG. 1 depicts an embodiment in which the below-described computer-implemented method is performed by a single computing device 12, embodiments are not limited thereto. For example, embodiments may be configured as networked computing devices, such that any number of computing devices may be communicatively coupled to perform the methods described herein in a distributed computing manner.

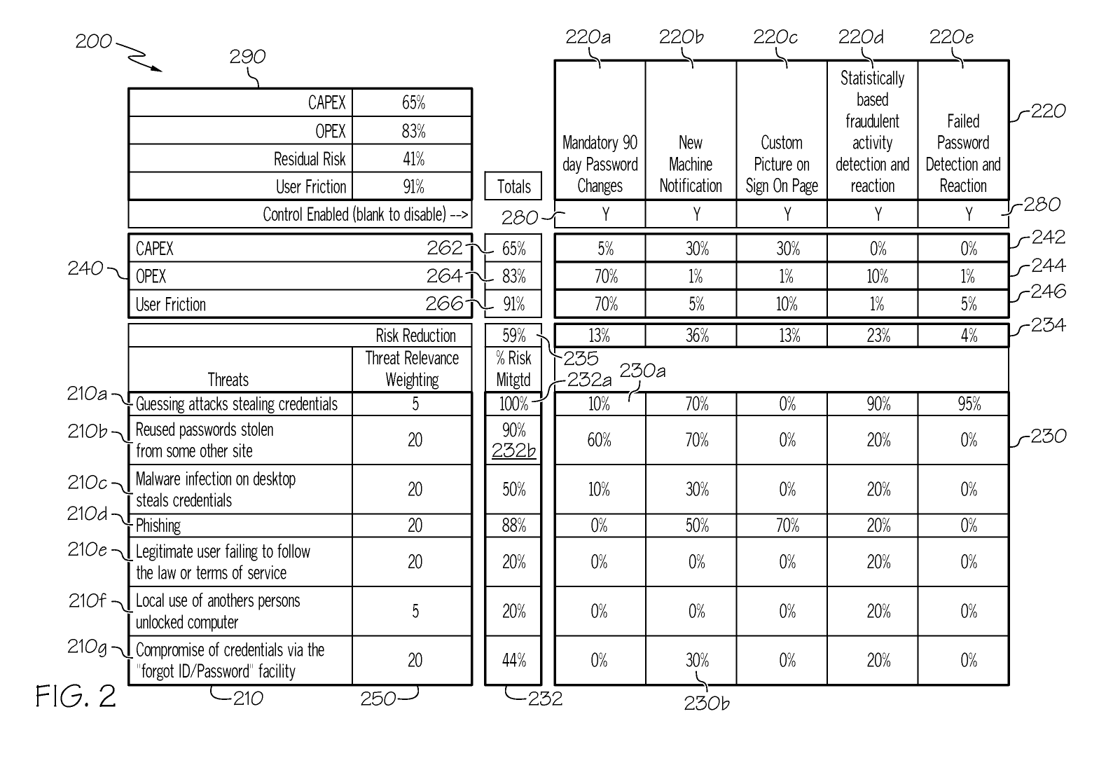

FIG. 2 depicts a graphical user interface 200 for facilitating the determination of an amount by which an overall risk associated with a plurality of threats is modified by implementing a first combination of security controls. The graphical user interface 200 may be displayed on a display device of the computing device 12 and may be configured to receive user input. In some embodiments, the graphical user interface 200 may be implemented as a worksheet or spreadsheet, such as a Microsoft Excel worksheet. In other embodiments, the graphical user interface 200 may be a stand-alone computer program specifically designed for the applications described herein.

The graphical user interface 200 includes a plurality of threats 210. In some embodiments, the plurality of threats 210 may be retrieved from the data storage component 36 and received by the memory component 40 and/or the processor 30. In some embodiments, the plurality of threats 210 may be received as user input from a user of the computing device 12. In some embodiments, the portion of the user interface that displays the plurality of threats 210 may be configured and edited by the user.

The plurality of threats 210 include a first threat 210a, a second threat 210b, a third threat 210c, a fourth threat 210d, a fifth threat 210e, a sixth threat 210f, and a seventh threat 210g. Each of the plurality of threats 210 represents a possible security threat or risk factor associated with access to a computer system or database. The first threat 210a represents the threat that login credentials may be stolen through a guessing attack, such as an attacker guessing a username/password combination. The second threat 210b represents a threat that a user's password may be stolen from another site and used by another to gain access to a computer system or database. The third threat 210c represents a threat that a malware infection on a user's desktop may steal credentials that may be used to gain access to a computer system or database. The fourth threat 210d represents a threat that username or password information may be fraudulently obtained through a phishing scheme, such as when a user is duped into providing their username and password in an e-mail, or the like. The fifth threat 210e represents the threat that a legitimate or otherwise authorized user may fail to follow the law or terms of service, such as by accessing an unauthorized portion of a computer system or database or using a piece of retrieved information for an unlawful purpose. The sixth threat 210f represents the threat of local use of an unlocked computer by an attacker, such as when an authorized user steps away from his or her computer while logged into a computer system or database and an unauthorized user gains access to the computer system or database when the authorized user steps away from the computer without locking the computer. The seventh threat 210g represents the threat that user credentials may be compromised through a forgot ID or forgot password facility, such as when an unauthorized user has access to a forgot ID or forgot password recovery channel, the unauthorized user fraudulently submits a request to recover a forgotten ID and/or forgotten password, and the unauthorized user uses the recovered ID or password retrieved from the recovery channel.

While seven threats are included in the plurality of threats 210 depicted in the graphical user interface 200, it should be understood that in other embodiments, more or less than seven threats may be included. Furthermore, in other embodiments, the plurality of threats 210 may be presented differently in the graphical user interface 200, such as when the plurality of threats 210 is presented as a series of columns instead of a series of rows, or when the plurality of threats 210 is located in a different position of the graphical user interface 200.

Still referring to FIG. 2, the graphical user interface 200 includes a plurality of security controls 220. In some embodiments, the plurality of security controls 220 may be retrieved from the data storage component 36 and received by the memory component 40 and/or the processor 30. In some embodiments, the plurality of security controls 220 may be received as user input from a user of the computing device 12. In some embodiments, the portion of the user interface that displays the plurality of security controls 220 may be configured and edited by the user.

The plurality of security controls 220 include a first security control 220a, a second security control 220b, a third security control 220c, a fourth security control 220d, and a fifth security control 220e. Each of the plurality of security controls 220 represents a possible security control that may be implemented to reduce one or more of the plurality of threats 210. The first security control 220a is a mandatory password change every 90 days. The second security control 220b is a new machine notification, which may require a user to register a new machine in some manner before allowing accessing to a computer system or database via the new machine. The third security control 220c is a custom picture on the sign on page, which may include a user-selected picture that is displayed each time a user signs in to access the computer system or database to allow the user to ensure that the user-selected picture is present on the sign on page, which may prevent an attacker from fraudulently obtaining login credentials from a spoofed sign on page. The fourth security control 220d is a statistically based fraudulent activity detection and reaction control, which may monitor account access information or other parameters to detect when fraudulent activity occurs and take some reactive action, such as limiting account access, requesting further verification, or the like. The fifth security control 220e is a failed password detection and reaction control, which may detect when an incorrect password has been entered a threshold number of times (e.g., one failed password attempt, two failed password attempts, three failed password attempts, etc.) and take reactive action, such as limiting account access, requesting further verification, or the like, when the threshold number of failed password attempts has occurred.

While five security controls are included in the plurality of security controls 220 depicted in the graphical user interface 200, it should be understood that in other embodiments, more or less than five security controls may be included. Furthermore, in other embodiments, the plurality of security controls 220 may be presented differently in the graphical user interface 200, such as when the plurality of security controls 220 is presented as a series of rows instead of a series of columns, or when the plurality of security controls 220 is located in a different position of the graphical user interface 200.

Still referring to FIG. 2, the graphical user interface includes a plurality of security control enabled boxes 280. When one of the plurality of security control enabled boxes 280 is active (e.g., by entering a “Y” in the cell, checking a box, or the like), the corresponding security control (e.g., the security control in the same column as the activated security control enabled box) will be included in the first combination of security controls that will be used to calculate the overall risk modification and other metrics, as described in detail below. For example, in FIG. 2, each of the plurality of security control enabled boxes 280 are active, indicating that all five of the plurality of security controls 220 will be included in the first combination of security controls under evaluation in the graphical user interface 200. While the embodiment depicted in FIG. 2 includes security control enabled boxes 280, it should be understood that other embodiments may allow a user to select a combination of the plurality of security controls in a manner other than through interaction with a security control enabled box.

The graphical user interface 200 also includes a plurality of individual risk modification amounts 230. In some embodiments, the plurality of individual risk modification amounts 230 may be retrieved from the data storage component 36 and received by the memory component 40 and/or the processor 30. In some embodiments, the plurality of individual risk modification amounts 230 may be received as user input from a user of the computing device 12.

Each of the individual risk modification amounts of the plurality of individual risk modification amounts 230 corresponds to a corresponding security control and a corresponding threat. For example, in the embodiment depicted in FIG. 2, a particular individual risk modification amount of the plurality of individual risk modification amounts 230 corresponds to the security control of the column of the particular individual risk modification amount and the threat of the row of the particular individual risk modification amount. For example, a first individual risk modification amount 230a corresponds to the first threat 210a and the first security control 220a. A second individual risk modification amount 230b corresponds to the seventh threat 210g and the second security control 220b. Each of the individual risk modification amounts of the plurality of risk modification amounts is indicative of an amount by which a risk associated with the corresponding threat is modified by implementing the corresponding security control. Referring to the same example, the first individual risk modification amount 230a is 10%, which is indicative of a 10% reduction in risk of the first threat 210a (stealing credentials via a guessing attack) when the first security control 220a (a mandatory 90 day password change) is implemented. The second individual risk modification amount 230b is 30%, which is indicative of a 30% reduction in risk of the seventh threat 210g (compromise of credentials via a forgot ID/forgot password facility) when the second security control 220b (new machine notification) is implemented. Each of the individual risk modification amounts of the plurality of individual risk modification amounts may be manually entered into the graphical user interface 200 (e.g., when the graphical user interface 200 is implemented as a spreadsheet or similar computer program). In other embodiments, the individual risk modification amounts of the plurality of individual risk modification amounts may be automatically calculated (e.g., based on experiential or empirical data received from an external source, etc.).

Still referring to FIG. 2, the graphical user interface 200 includes an overall risk modification amount 235. The overall risk modification amount 235 is indicative of the amount by which the overall risk associated with the plurality of threats 210 is modified by implementing the first combination of security controls that are enabled. The first combination of security controls that are enabled includes each of the security controls security control for which the corresponding security control enabled box is active. In the graphical user interface 200 of FIG. 2, the first combination of security controls that are enabled includes all five of the plurality of security controls 220. The overall risk modification amount 235 may be automatically determined by the computing device 12 based on the plurality of individual risk modification amounts 230.

In some embodiments, the overall risk modification amount 235 may be automatically determined based on a plurality of threat risk modification amounts 232. Each of the plurality of threat risk modification amounts may be indicative of a degree by which a risk associated with a threat is modified by implementing the first combination of security controls. For example, in FIG. 2, the plurality of threat risk modification amounts 232 includes a first threat risk modification amount 232a and a second threat risk modification amount 232b. The first threat risk modification amount 232a is indicative of a degree by which a risk associated with the first threat 210a is modified by implementing all five of the security controls included in the first combination of security controls. The second threat risk modification amount is indicative of a degree by which a risk associated with the second threat 210b is modified by implementing all five of the security controls of the first combination of security controls.

The first threat risk modification amount 232a may be determined based on a first subset of the plurality of individual risk modification amounts 230 that correspond to the first threat 210a. The first subset includes all of the plurality of individual risk modification amounts 230 that are in the row of the first threat 210a and in a column of an enabled security control of the first combination of security controls (i.e., all five security controls in this case). In some embodiments, the first threat risk modification amount 232a is calculated as 100%−[(100%−the first individual risk modification amount of the first subset)*(100%−the second individual risk modification amount of the first subset)* . . . *(100%−the last individual risk modification amount of the first subset s). Applying this formula to the numbers depicted in FIG. 2, the first threat risk modification amount 232a shown in FIG. 2 is calculated as 100%−[(100%−10%)*(100%−70%)*(100%−0%)*(100%−90%)*(100%−95%)]=100% [90%*30%*100%*10%*5%]=100%−0%=100%. However, it should be understood that in other embodiments, the first threat risk modification amount 232a may be calculated differently.

The second threat risk modification amount 232b may be determined based on a second subset of the plurality of individual risk modification amounts 230 that correspond to the second threat 210b. The second subset includes all of the plurality of individual risk modification amounts 230 that are in the row of the second threat 210b and in a column of an enabled security control of the first combination of security controls (i.e., all five security controls in this case). In some embodiments, the second threat risk modification amount 232b is calculated as 100%−[(100%−the first individual risk modification amount of the second subset)*(100%−the second individual risk modification amount of the second subset)* . . . * (100%−the last individual risk modification amount of the second subset)]. Applying this formula to the numbers depicted in FIG. 2, the second threat risk modification amount 232b shown in FIG. 2 is calculated as 100%−[(100%−60%)*(100%−70%)*(100%−0%)*(100%−20%)*(100%−0%)]=100%−[40%*30%*100%*80%*100%]=100%-10%=90%. However, it should be understood that in other embodiments, the second threat risk modification amount 232b may be calculated differently.

The overall risk modification amount 235 may then be determined based on the plurality of threat risk modification amounts 232. For example, in some embodiments, the overall risk modification amount may be a sum of the plurality of threat risk modification amounts 232, a product of the plurality of threat risk modification amounts 232, a sum-product of the plurality of threat risk modification amounts 232, or another function of the plurality of threat risk modification amounts 232.

In other embodiments, such as the embodiment depicted in FIG. 2, the overall risk modification amount 235 may be determined based on the plurality of threat risk modification amounts 232 and a plurality of threat relevance weightings 250. Each of the plurality of threat relevance weightings 250 is indicative of an expected relevance of the corresponding threat of the plurality of threats 210 that is in the corresponding row of the particular threat relevance weighting. A low threat relevance weighting indicates an expected low relevance of the threat (e.g., the threat may not be considered to be that important or likely), while a high threat relevance weighting indicates an expected high relevance of the threat (e.g., the threat may be considered to be important or likely). Specifically, in the illustrated examples, the first threat 210a has a threat relevance weighting of 5, the second threat 210b has a threat relevance weighting of 20, the third threat 210c has a threat relevance weighting of 20, the fourth threat 210d has a threat relevance weighting of 20, the fifth threat 210e has a threat relevance weighting of 20, the sixth threat 210f has a threat relevance weighting of 5, and the seventh threat 210g has a threat relevance weighting of 20. In some embodiments, the threat relevance weighting may be a threat frequency weighting indicative of an expected frequency of the corresponding threat of the plurality of threats 210 that is in the corresponding row of the particular threat frequency weighting.

In some embodiments, the overall risk modification amount 235 is calculated as: (the sum-product of the plurality of individual risk modification amounts 230 and the plurality of threat relevance weightings 250), divided by the plurality of threat relevance weightings 250. The sum-product of the plurality of individual risk modification amounts 230 and the plurality of threat relevance weightings 250 may be calculated as: [(the threat risk modification amount corresponding to the first threat*the threat relevance weighting corresponding to the first threat)+(the threat risk modification amount corresponding to the second threat*the threat relevance weighting corresponding to the second threat)+ . . . +(the threat risk modification amount corresponding to the last threat*the threat relevance weighting corresponding to the last threat)]/(the sum of the plurality of threat relevance weightings 250). Specifically, the overall risk modification amount 235 depicted in FIG. 2 is calculated as [((5*100%)+(20*90%)+(20*50%)+(20*88%)+(20*20%)+(5*20%)+(20*44%))]/(5+20+20+20+20+5+20)=56%. However, it should be understood that the overall risk modification amount 235 may be calculated differently in other embodiments, such as when the overall risk modification amount 235 is calculated as a simple sum-product of the plurality of individual risk modification amounts 230 and the plurality of threat relevance weightings 250 or as another function of the plurality of individual risk modification amounts 230 and the plurality of threat relevance y weightings 250.

In some embodiments, the overall risk modification amount 235 is a risk reduction percentage indicative of an amount by which an overall risk associated with a plurality of threats is reduced or mitigated by implementing a combination of security controls. In some embodiments, the overall risk modification amount 235 is a remaining risk percentage, indicative of an amount of risk remaining after implementing a combination of security controls. In other embodiments, the overall risk modification amount 235 may be a number other than a percentage, or may be a textual (e.g. low, medium, or high) or graphical indication (e.g. green, yellow, red) of risk modification.

Still referring to the graphical user interface 200, the implementation of each of the plurality of security controls 220 may be measured by one or more metrics 240, which may allow a comparison of different combinations of implemented security controls on the basis of the one or more metrics 240, as will be described in further detail below. For example, in the graphical user interface 200, values for three metrics (capital expense (CAPEX), operating expense (OPEX), and user friction) associated with the implementation of each of the plurality of security controls 220 are depicted in the three rows immediately below the security control enabled boxes 280.

A plurality of individual capital expense values 242 are depicted in the CAPEX row of the graphical user interface 200. Each of the plurality of individual capital expense values 242 corresponds to an initial capital cost to implement the corresponding security control of the column of the particular capital expense value (100% represents the largest initial capital cost; 0% means it is either “free” to implement, or it has already been included in systems in which the security control may be implemented).

A plurality of individual operational expense values 244 are depicted in the OPEX row of the graphical user interface 200. Each of the plurality of individual operational expense values 244 corresponds to a cost to operate the corresponding security control of the column of the particular individual operating expense value (100% represents the largest operational cost; 0% means it is either “free” to operate, or it has already been included in systems in which the security control may be implemented).

A plurality of individual user friction values 246 are depicted in the user friction row of the graphical user interface 200. Each of the plurality of individual user friction values 246 corresponds to a percentage of additional “drag” in the user experience that would be introduced by implementing the corresponding security control of the column of the particular individual user friction value. An individual user friction value of 100% means that every user will be unhappy every time the security control is implemented and/or that the security control may interfere with the user experience frequently. An individual user friction value of 0 means that a user may barely notice the corresponding security control and/or that the security control may not interfere with the user experience frequently.

While the values and metrics are depicted as percentages in FIG. 2, it should be understood that in other embodiments, one or more of the metrics may not be a percentage, such as when the metrics are measured as whole numbers, as decimals, as units of expense (e.g., dollars), or the like.

A metric total may be calculated for each of the one or more metrics 240. The metric total is indicative of a cumulative amount of a metric incurred by implementing the first combination of security controls that are enabled. For example, in FIG. 2, a capital expense total 262 is calculated based on the plurality of individual capital expense values 242 for the first combination of security controls that are enabled (all five security controls in this case). The capital expense total 262 is indicative of the overall capital expense associated with implementing the first combination of security controls. The capital expense total 262 of FIG. 2 is calculated by summing the plurality of individual capital expense values 242 for the first combination of security controls that are enabled. However, it should be understood that in other embodiments, the capital expense total 262 may be calculated in another manner, such as a product of the plurality of individual capital expense values 242, or as another function of the plurality of individual capital expense values 242. The capital expense total 262 provides an indication of the total impact of the combination of security controls on capital expense, which may be used to decide whether to implement the combination of security controls, which will be described further below.

Still referring to FIG. 2, an operational expense total 264 is calculated based on the plurality of individual operational expense values 244 for the first combination of security controls that are enabled. The operational expense total 264 is indicative of the overall operational expense associated with implementing the first combination of security controls. The operational expense total 264 of FIG. 2 is calculated by summing the plurality of individual operational expense values 244 for the first combination of security controls that are enabled. However, it should be understood that in other embodiments, the operational expense total 264 may be calculated in another manner, such as a product of the plurality of individual operational expense values 244, or as a function of the plurality of individual operational expense values 244. The operational expense total 264 provides an indication of the total impact of the combination of security controls on operational expense, which may be used to decide whether to implement the combination of security controls, which will be described further below.

Still referring to FIG. 2, a user friction total 266 is calculated based on the plurality of individual user friction values 246 for the first combination of security controls that are enabled. The user friction total 266 is indicative of the overall user friction associated with implementing the first combination of security controls. The user friction total 266 of FIG. 2 is calculated by summing the plurality of individual user friction values 246 for the first combination of security controls that are enabled. However, it should be understood that in other embodiments, the user friction total 266 may be calculated in another manner, such as a product of the plurality of individual user friction values 246, or as a function of the plurality of individual user friction values 246. The user friction total 266 provides an indication of the total impact of the combination of security controls on user friction, which may be used to decide whether to implement the combination of security controls, which will be described further below.

Still referring to FIG. 2, the graphical user interface 200 includes an optional summary portion 290 that indicates a summary of the calculated risk modification and metrics associating with implementing the first combination of security controls that are enabled in FIG. 2. The summary portion 290 includes the capital expense total, the operating expense total, the user friction total, and a “residual risk.” The “residual risk” of the summary portion 290 is indicative of the remaining risk associated with the plurality of threats 210 after the combination of security controls is implemented. The “residual risk” is calculated as 100% minus the overall risk modification amount 235. The summary portion 290 may include more of less information than is depicted in FIG. 2 and may be presented in a different manner. Furthermore, some embodiments may not include the summary portion 290.

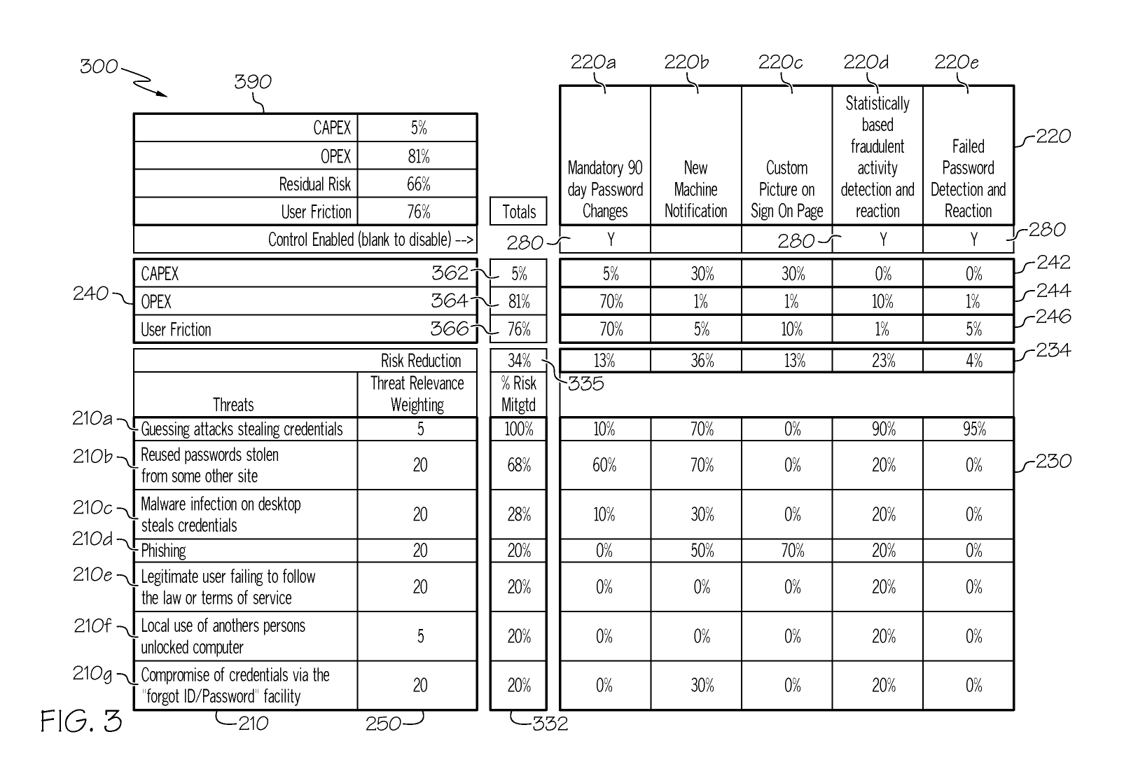

Referring now to FIG. 3, a graphical user interface 300 for facilitating the determination of an amount by which an overall risk associated with a plurality of threats is modified by implementing a second combination of security controls is schematically depicted. The graphical user interface 300 includes the plurality of threats 210, the plurality of security controls 220, the plurality of individual risk modification amounts 230, and the plurality of threat relevance weightings 250 as described above with respect to the graphical user interface 200 of FIG. 2 so that calculations directed to the second combination of security controls can be directly compared to similar calculations directed to other combinations of security controls.

As depicted in FIG. 3, the second combination of security controls includes the first security control 220a, the fourth security control 220d, and the fifth security control 220e (indicated by the active security control enabled boxes 280 beneath the first security control 220a, the fourth security control 220d, and the fifth security control 220e).

The graphical user interface 300 includes an overall risk reduction amount 335. The overall risk reduction amount 335 is indicative of the amount by which the overall risk associated with the plurality of threats 210 is modified by implementing the second combination of security controls (the first security control 220a, the fourth security control 220d, and the fifth security control 220e). The overall risk reduction amount 335 may be calculated based on the plurality of individual risk modification amounts 230 in any of the ways that the overall risk modification amount 235 of FIG. 2 was calculated based on the plurality of individual risk modification amounts 230, as described above. Similarly, the capital expense total 362, the operational expense total 364, and the user friction total 366 may be calculated in the same manner as described above with respect to the respective capital expense total 262, the operational expense total 264, and the user friction total 266 of FIG. 2. The graphical user interface 300 may also include an optional summary portion 390 that indicates a summary of the risk modification and metrics associating with implementing the second combination of security controls enabled in FIG. 3.

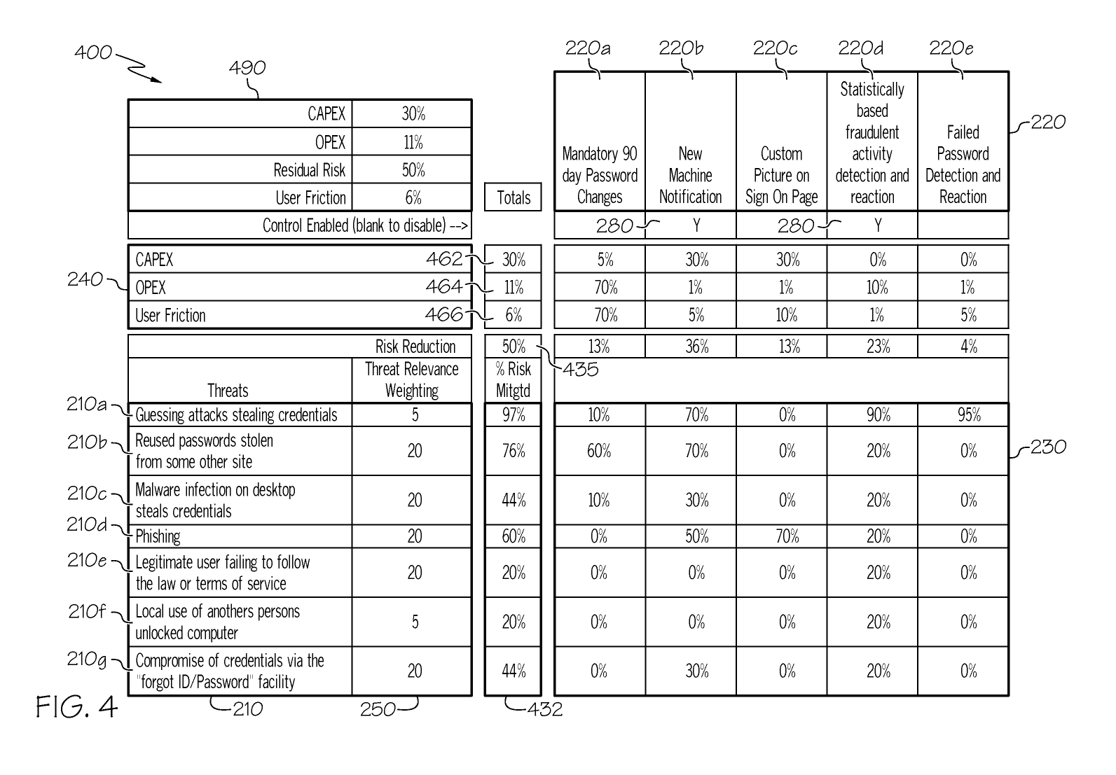

Referring now to FIG. 4, a graphical user interface 400 for facilitating the determination of an amount by which an overall risk associated with a plurality of threats is modified by implementing a third combination of security controls is schematically depicted. The graphical user interface 400 includes the plurality of threats 210, the plurality of security controls 220, the plurality of individual risk modification amounts 230, and the plurality of threat relevance weightings 250 as described above with respect to the graphical user interface 200 of FIG. 2.

As depicted in FIG. 4, the third combination of security controls includes the second security control 220b and the fourth security control 220d (indicated by the active security control enabled boxes 280 beneath the second security control 220b and the fourth security control 220d).

The graphical user interface 400 includes an overall risk reduction amount 435. The overall risk reduction amount 435 is indicative of the amount by which the overall risk associated with the plurality of threats 210 is modified by implementing the third combination of security controls (the second security control 220b and the fourth security control 220d). The overall risk reduction amount 435 may be calculated based on the plurality of individual risk modification amounts 230 in any of the ways that the overall risk modification amount 235 of FIG. 2 was calculated based on the plurality of individual risk modification amounts 230, as described above. Similarly, the capital expense total 462, the operational expense total 464, and the user friction total 466 may be calculated in the same manner as described above with respect to the respective capital expense total 262, the operational expense total 264, and the user friction total 266 of FIG. 2. The graphical user interface 400 may also include an optional summary portion 490 that indicates a summary of the risk modification and metrics associating with implementing the second combination of security controls enabled in FIG. 4.

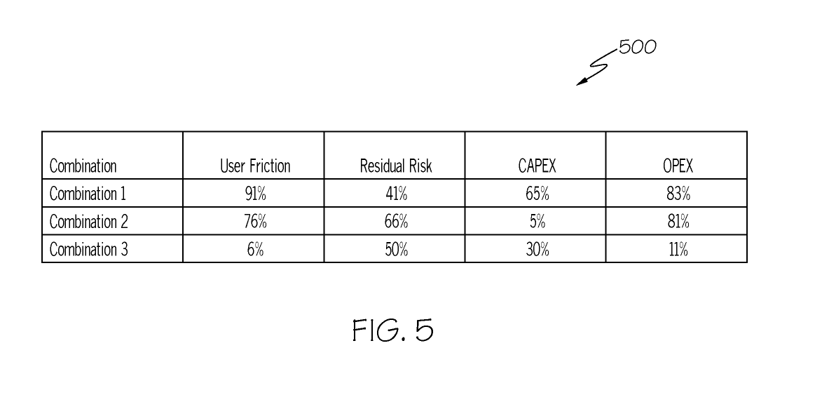

By calculating the overall risk modification amounts and other metrics associated with implementing different combinations of security controls and presenting such information to a user, a user may be able to understand the tradeoffs associated with implementing the various combinations of security controls, thereby enabling the user to evaluate which combination of security controls to implement. Referring now to FIG. 5, a graphical display 500 is depicted. The graphical display 500 includes the user friction totals, residual risk totals, capital expense totals, and operating expense totals of each of combination 1 (corresponding to the first combination of security controls enabled in FIG. 2), combination 2 (corresponding to the second combination of security controls enabled in FIG. 3), and combination 3 (corresponding to the third combination of security controls enabled in FIG. 4). From the depicted information, it can be seen that combination 1 may minimize risk compared to the other combinations, but may do so at the expense of much higher user friction and much higher capital expense costs and operating expense costs. Presenting such information related to various combinations of security controls may allow a user to quickly and easily understand the relative benefits and tradeoffs associated with implementing various combinations of security control and use this information to make a principled decision on which particular combination of security controls to implement based on a set of evaluation parameters.

In some embodiments, the computing device 12 may suggest a particular combination of security controls to implement from a number of possible combinations of security controls based the overall risk modification amounts and/or other metrics associated with each of the possible combinations of security controls.

While the embodiments depicted and described above were presented in the context of a series of user interfaces, it should be understood that the methods described herein may be implemented in a manner that does not require such a graphical user interface. For example, any of the plurality of individual risk modification amounts, the plurality of threat relevance weightings, the plurality of individual capital expense amounts, the plurality of individual operational expense amounts, the plurality of individual user friction amounts, and the like may be received in another way, such as from data stored in the data storage component 36 or when a user is prompted to enter the information via a software program that receives input from the user in a manner other than a graphical user interface as described and depicted herein. For example, in some embodiments, the data processed herein may have been received by the computing device 12 and stored in the data storage component 36 for later access and/or processing by the computing device 12. In some embodiments, the data processed herein may have been received by the computing device 12 and stored in the memory component 40 for immediate access and/or processing by the computing device 12.

Furthermore, while the above functionality was described in the context of a single computing device 12, it should be understood that embodiments are not limited thereto. In other embodiments, one or more of the components described above or one or more of the steps described above may be distributed among one or more additional computing devices. For example, a computing network may connect the computing device 12 to one or more additional computing devices or servers and the functionality described herein may be implemented among multiple computing devices on the network.

It should be understood that embodiments described herein provide for systems and methods for determining an overall risk modification amount indicative of an amount by which an overall risk associated with a plurality of threats is modified by implementing a combination of security controls. The systems and methods described herein may provide a powerful methodology by which the complicated and intertwined interrelation of multiple individual security controls and multiple possible threat scenarios may combine to influence an overall risk modification that results from implementing a combination of security controls. By understanding the overall risk modification amount associated with implementing a plurality of security controls, an evaluation can be made of whether a particular combination of security controls is effective. Furthermore, by calculating the overall risk modification amounts and other metrics associated with implementing different combinations of security controls and presenting such information to a user, a user may be able to understand the tradeoffs associated with implementing the various combinations of security controls, thereby enabling the user to evaluate which combination of security controls to implement.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computer-implemented method for determining an overall risk modification amount indicative of an amount by which an overall risk associated with a plurality of threats is modified by implementing a combination of security controls, the method comprising:
receiving a plurality of individual risk modification amounts, wherein each individual risk modification amount corresponds to a corresponding security control of the combination of security controls and a corresponding threat of the plurality of threats, wherein each individual risk modification amount of the plurality of individual risk modification amounts is indicative of an amount by which a risk associated with the corresponding threat is modified by implementing the corresponding security control; and
determining, automatically by a computer, the overall risk modification amount based on the plurality of individual risk modification amounts, wherein the overall risk modification amount is indicative of the amount by which the overall risk associated with the plurality of threats is modified by implementing the combination of security controls.

2. The computer-implemented method of claim 1, the method further comprising:
determining a plurality of threat risk modification amounts based on a plurality of subsets of the plurality of individual risk modification amounts, wherein each of the plurality of threat risk modification amounts is associated with a corresponding subset of the plurality of individual risk modification amounts, wherein each of the plurality of subsets corresponds to a threat of the plurality of threats, wherein each of the plurality of threat risk modification amounts is indicative of a degree by which a risk associated with a corresponding threat is modified by implementing the combination of security controls;
wherein the overall risk modification amount is determined based on the plurality of threat risk modification amounts.

3. The computer-implemented method of claim 2, further comprising:
receiving a plurality of threat relevance weightings, wherein each of the plurality of threat relevance weightings is indicative of an expected relevance of a corresponding threat, wherein the overall risk modification amount is determined based on the plurality of threat relevance weightings and the plurality of threat risk modification amounts.

4. The computer-implemented method of claim 1, further comprising:
receiving a plurality of individual capital expense amounts, wherein each individual capital expense amount of the plurality of individual capital expense amounts corresponds to a corresponding security control of the combination of security controls, wherein each individual capital expense amount is indicative of a capital expense amount associated with implementing the corresponding security control; and
determining a capital expense total based on the plurality of individual capital expense amounts, wherein the capital expense total is indicative of an overall capital expense associated with implementing the combination of security controls.

5. The computer-implemented method of claim 1, further comprising:
receiving a plurality of individual operating expense amounts, wherein each individual operating expense amount of the plurality of individual operating expense amounts corresponds to a corresponding security control of the combination of security controls, wherein each individual operating expense amount is indicative of an operating expense amount associated with implementing the corresponding security control; and
determining an operating expense total based on the plurality of individual operating expense amounts, wherein the operating expense total is indicative of an overall operating expense associated with implementing the combination of security controls.

6. The computer-implemented method of claim 1, further comprising:
receiving a plurality of individual user friction amounts, wherein each individual user friction amount of the plurality of individual user friction amounts corresponds to a corresponding security control of the combination of security controls, wherein each individual user friction amount is indicative of a user friction amount associated with implementing the corresponding security control; and
determining a user friction total based on the plurality of individual user friction amounts, wherein the user friction total is indicative of an overall user friction associated with implementing the combination of security controls.

7. The computer-implemented method of claim 1, wherein the overall risk modification amount is a remaining risk percentage.

8. The computer-implemented method of claim 1, wherein the overall risk modification amount is a risk reduction percentage.

9. The computer-implemented method of claim 1, wherein the plurality of individual risk modification amounts and the overall risk modification amount are percentages in a range from 0% to 100%.

10. A system for determining an overall risk modification amount indicative of an amount by which an overall risk associated with a plurality of threats is modified by implementing a combination of security controls, the system comprising:
a computing device that comprises a non-transitory memory component that stores a set of executable instructions that causes the computing device to:
receive a plurality of individual risk modification amounts, wherein each individual risk modification amount corresponds to a corresponding security control of the combination of security controls and a corresponding threat of the plurality of threats, wherein each individual risk modification amount of the plurality of individual risk modification amounts is indicative of an amount by which a risk associated with the corresponding threat is modified by implementing the corresponding security control; and
determine the overall risk modification amount based on the plurality of individual risk modification amounts, wherein the overall risk modification amount is indicative of the amount by which the overall risk associated with the plurality of threats is modified by implementing the combination of security controls.

11. The system of claim 10, wherein the set of executable instructions further cause the computing device to:
determine a plurality of threat risk modification amounts based on a plurality of subsets of the plurality of individual risk modification amounts, wherein each of the plurality of threat risk modification amounts is associated with a corresponding subset of the plurality of individual risk modification amounts, wherein each of the plurality of subsets corresponds to a threat of the plurality of threats, wherein each of the plurality of threat risk modification amounts is indicative of a degree by which a risk associated with a corresponding threat is modified by implementing the combination of security controls;
wherein the overall risk modification amount is determined based on the plurality of threat risk modification amounts.

12. The system of claim 11, wherein the set of executable instructions further cause the computing device to:
receive a plurality of threat relevance weightings, wherein each of the plurality of threat relevance weightings is indicative of an expected relevance of a corresponding threat, wherein the overall risk modification amount is determined based on the plurality of threat relevance weightings and the plurality of threat risk modification amounts.

13. The system of claim 10, wherein the set of executable instructions further cause the computing device to:
receive a plurality of individual capital expense amounts, wherein each individual capital expense amount of the plurality of individual capital expense amounts corresponds to a corresponding security control of the combination of security controls, wherein each individual capital expense amount is indicative of a capital expense amount associated with implementing the corresponding security control; and
determine a capital expense total based on the plurality of individual capital expense amounts, wherein the capital expense total is indicative of an overall capital expense associated with implementing the combination of security controls.

14. The system of claim 10, wherein the set of executable instructions further cause the computing device to:
receive a plurality of individual operating expense amounts, wherein each individual operating expense amount of the plurality of individual operating expense amounts corresponds to a corresponding security control of the combination of security controls, wherein each individual operating expense amount is indicative of an operating expense amount associated with implementing the corresponding security control; and
determine an operating expense total based on the plurality of individual operating expense amounts, wherein the operating expense total is indicative of an overall operating expense associated with implementing the combination of security controls.

15. The system of claim 10, wherein the set of executable instructions further cause the computing device to:
receive a plurality of individual user friction amounts, wherein each individual user friction amount of the plurality of individual user friction amounts corresponds to a corresponding security control of the combination of security controls, wherein each individual user friction amount is indicative of a user friction amount associated with implementing the corresponding security control; and
determine a user friction total based on the plurality of individual user friction amounts, wherein the user friction total is indicative of an overall user friction associated with implementing the combination of security controls.

16. The system of claim 10, wherein the overall risk modification amount is a remaining risk percentage.

17. The system of claim 10, wherein the overall risk modification amount is a risk reduction percentage.

18. The system of claim 10, wherein the plurality of individual risk modification amounts and the overall risk modification amount are percentages in a range from 0% to 100%.

19. A computer-implemented method for determining an overall risk modification amount indicative of an amount by which an overall risk associated with a plurality of threats is modified by implementing a combination of security controls, the method comprising:
receiving a plurality of individual risk modification amounts, wherein each individual risk modification amount corresponds to a corresponding security control of the combination of security controls and a corresponding threat of the plurality of threats, wherein each individual risk modification amount of the plurality of individual risk modification amounts is indicative of an amount by which a risk associated with the corresponding threat is modified by implementing the corresponding security control;
determining, automatically by a computer, the overall risk modification amount based on the plurality of individual risk modification amounts, wherein the overall risk modification amount is indicative of the amount by which the overall risk associated with the plurality of threats is modified by implementing the combination of security controls; and
providing for display the overall risk modification amount on a display device.

20. The computer-implemented method of claim 19, the method further comprising:
determining a plurality of threat risk modification amounts based on a plurality of subsets of the plurality of individual risk modification amounts, wherein each of the plurality of threat risk modification amounts is associated with a corresponding subset of the plurality of individual risk modification amounts, wherein each of the plurality of subsets correspond to a threat of the plurality of threats, wherein each of the plurality of threat risk modification amounts is indicative of a degree by which a risk associated with a corresponding threat is modified by implementing the combination of security controls; and
receiving a plurality of threat relevance weightings, wherein each of the plurality of threat relevance weightings is indicative of an expected relevance of a corresponding threat, wherein the overall risk modification amount is determined based on the plurality of threat relevance weightings and the plurality of threat risk modification amounts.
